(19) United States
(12) Patent Application Publication
(10) Pub. No.: US 2011/0193829 A1
(43) Pub. Date: Aug. 11, 2011

(54) FLEXIBLE DISPLAY DEVICE

(75) Inventors: Tzeng-Shii Tsai, Hsinchu County (TW); Yu-Sheng Tsai, Hsinchu City (TW)

(73) Assignee: INDUSTRIAL TECHNOLOGY RESEARCH INSTITUTE, Hsinchu (TW)

(21) Appl. No.: 12/886,475

(22) Filed: Sep. 20, 2010

(30) Foreign Application Priority Data
Feb. 11, 2010 (TW) TW99104305

(51) Int. Cl. G09G 5/00

(52) U.S. Cl. 345/204

(57) ABSTRACT

A flexible display device includes an operating body, a flexible display panel and a flexible air bag. The flexible display panel, connecting to the operating body, is able to be scrolled to a stored status or unscrolled to an operating status. The flexible air bag is disposed on a bottom surface of the flexible display panel, wherein the flexible display panel is inflated or vacuumed when the flexible display panel is in the operating status in order to maintain a flat surface of the flexible display panel.

This Application claims priority of Taiwan Patent Application No. 099104305, filed on Feb. 11, 2010, the entirety of which is incorporated by reference herein.

### BACKGROUND

1. Technical Field

The disclosure relates to a flexible display device, and in particular, to a flexible display device which is convenient to carry around.

2. Related Art

A conventional flexible display device commonly comprises a container and a flexible display panel. The container comprises a housing, wherein essential electronic elements are disposed therein. Buttons for operating the flexible display panel are disposed on the housing. The flexible display panel connected to the operating body is able to be scrolled into the container, or folded outside of the container.

When the flexible display device is viewed, the flexible display must be maintained with a flat surface. Generally, to maintain a flat surface of the flexible display device, a mechanical support is used to mount two sides of the operating body of the flexible display device, such that the periphery of the flexible display panel is well supported. Meanwhile, a track type (as shown in US 2006/0107566A1), a roller type (as shown in US 2007/0241002A1) or a link type (as shown in US 2007/0211036A1) support may be mounted under the flexible display panels to fully expand the flexible display panel. However, the above described supports are complicated in structure and heavy in weight, such that even if the flexible display panel is stored away, it still takes up a lot of space and the flexible display device is not convenient to carry.

### SUMMARY

The disclosure provides a flexible display device. The flexible display device includes an operating body, a flexible display panel and a flexible air bag. The flexible display panel, connecting to the operating body, is able to be scrolled or folded to a stored status, and unscrolled or unfolded to an operating status. The flexible air bag is disposed on a bottom surface of the flexible display panel for inflation or deflation when the flexible display panel is in the operating status in order to maintain a flat surface of the flexible display panel.

A detailed description is given in the following embodiments with reference to the accompanying drawings.

### BRIEF DESCRIPTION OF THE DRAWINGS

The disclosure can be more fully understood by viewing the subsequent detailed description and examples with references made to the accompanying drawings, wherein:

FIG. 1 is a schematic view of a flexible display device of the embodiment;

FIG. 2A is a side view of the flexible display device of the embodiment showing the flexible display device in a stored status;

FIG. 2B is a side view of the flexible display device of the embodiment showing the flexible display device in an operating status;

FIG. 2C is a side view of the flexible display device of the embodiment showing the flexible display device inflated or vacuumed;

FIG. 3A is a sectional view showing portion A in FIG. 2C;

FIG. 3B is a sectional view showing portion A′ in FIG. 2C;

FIG. 3C is a sectional view showing portion A″ in FIG. 2C;

FIG. 4A is a top view of a variant embodiment of the flexible display device of the embodiment; and

FIG. 4B is a top view of another variant embodiment of the flexible display device of the embodiment.

### DETAILED DESCRIPTION

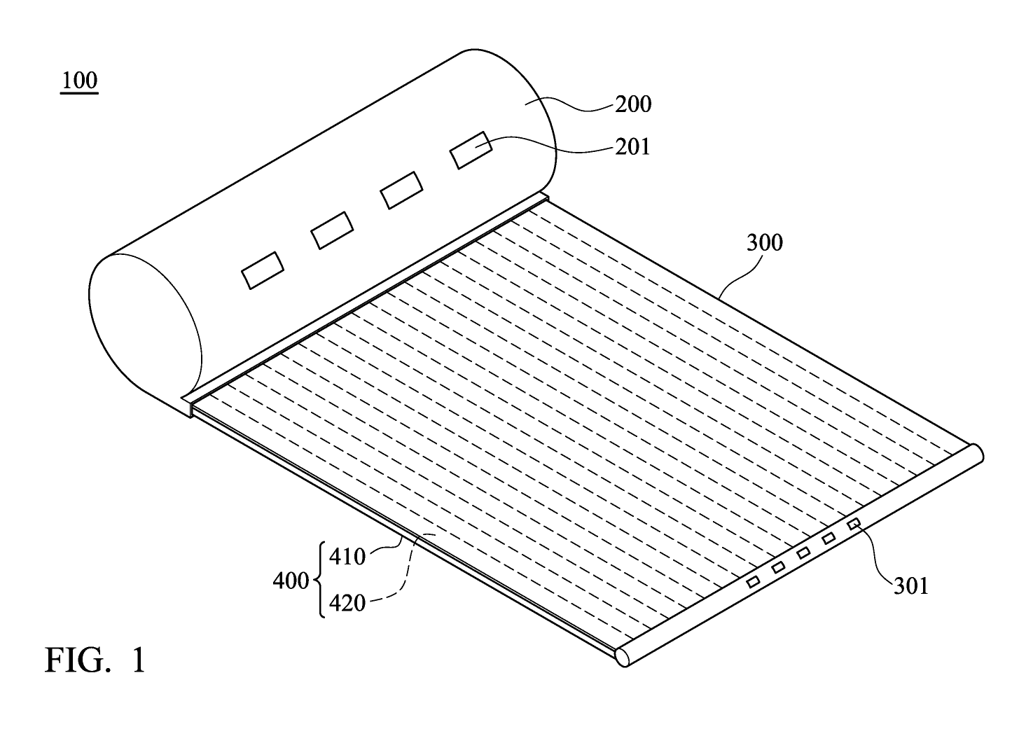

FIG. 1 is a schematic view of a flexible display device of the embodiment. As shown in FIG. 1, the embodiment provides a flexible display device 100 comprising an operating body 200, a flexible display panel 300 and a flexible air bag 400. The operating body 200 comprises a housing which includes all necessary electronic elements. Buttons 201 are disposed on the exterior of the housing 200 to operate the flexible display panel 300. The operating body 200 of the embodiment comprises a similar structure as that of the conventional flexible display device, and therefore detailed description is omitted.

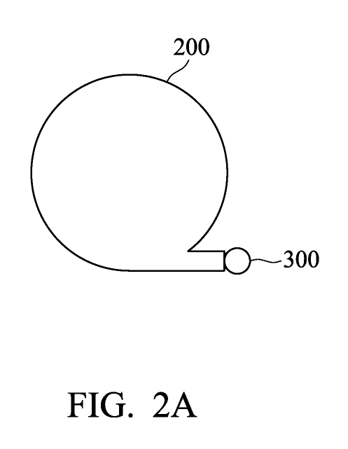

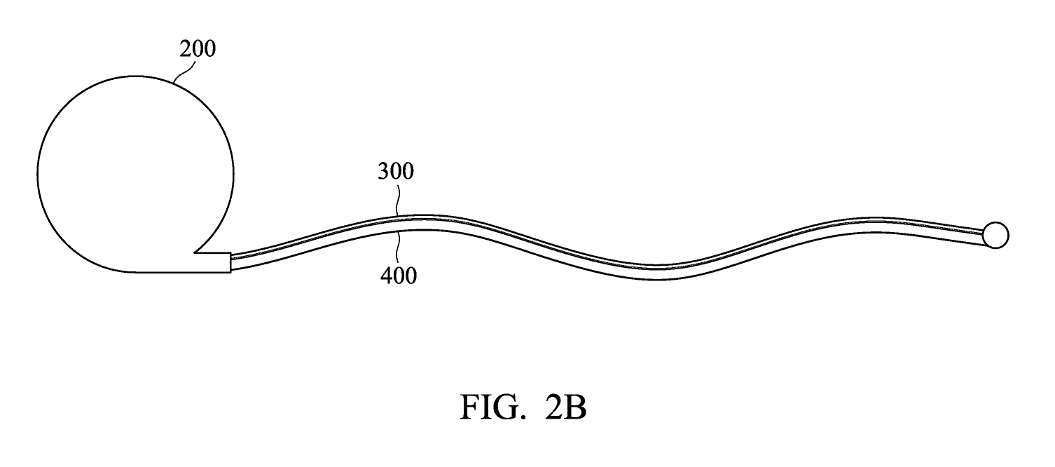

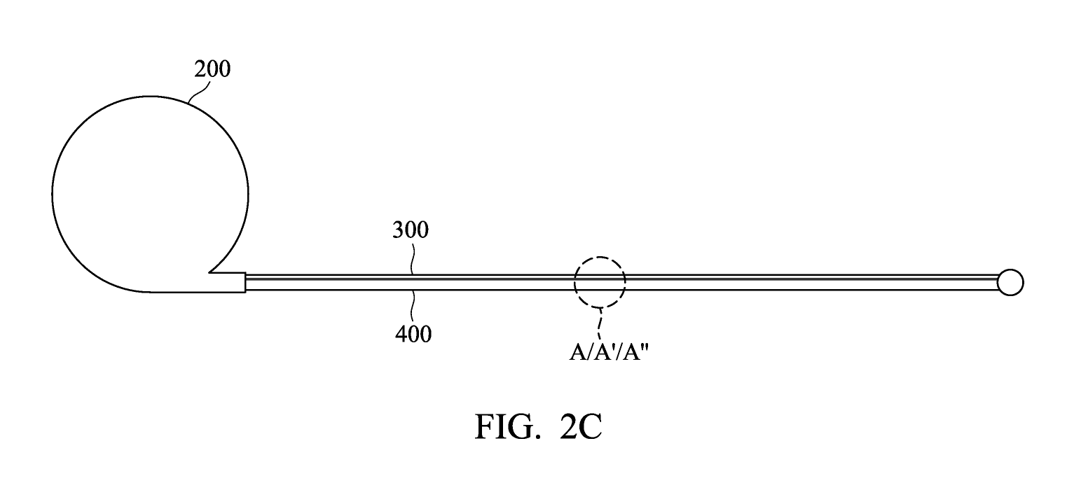

The flexible display panel 300 may comprise an electrophoretic display (EPD), a cholesteric liquid crystal displays (ChLCD), a quick response liquid powder display (QR-LPD) or an organic light emitting diodes (OLED). FIG. 2A is a side view of the flexible display device of the embodiment showing the flexible display device in a stored status; FIG. 2B is a side view of the flexible display device of the embodiment showing the flexible display device in an operating status. Referring to FIG. 1, the flexible display panel 300 is disposed in the operating body 200 by its inner end portions, and buttons 201 and 301 are disposed on the operation body and the outer end portion of the flexible display panel 300 to operate the flexible display device 100. The flexible display panel 300 may further comprise a touch member on its surface to provide similar operating functions of the buttons 201 and 301. The flexible display panel 300 is received and stored within the operating body 200 via the rotation of a scroll axle disposed in the operating body 200, and the outer end portion with the buttons 301 is exposed outside of the operating body 200. By pulling the outer end portion, the flexible display panel 300 is drawn out of the operating body 200 for the user to view. When the flexible display panel 300 is scrolled in the operating body 200, the flexible display panel 300 is in a stored status (as shown in FIG. 2A), and when the flexile display panel 300 is pulled out from the operating body 200, the flexible display panel 300 is in an operating status (as shown in FIG. 2B).

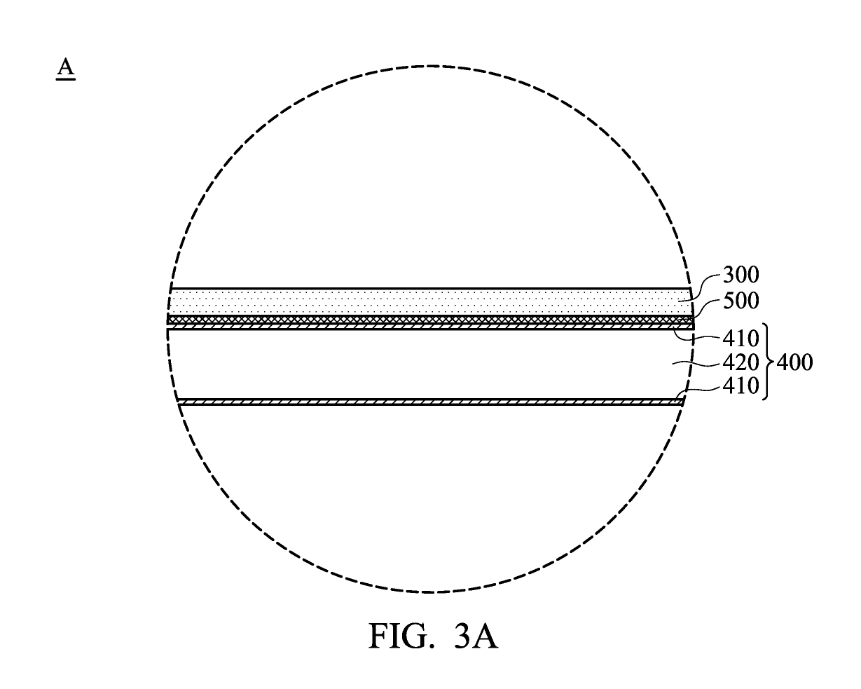

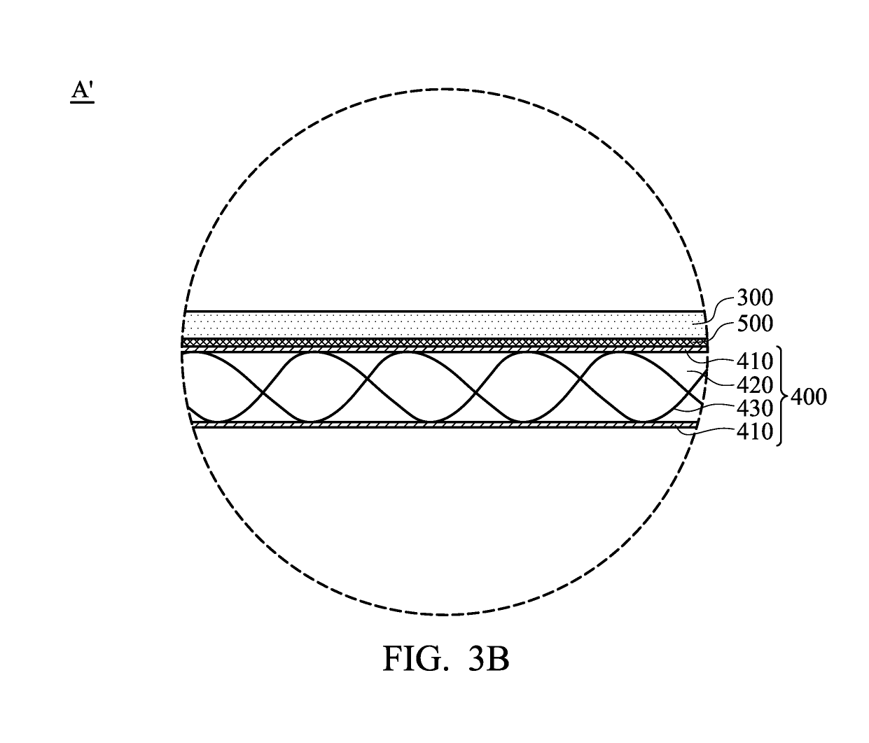

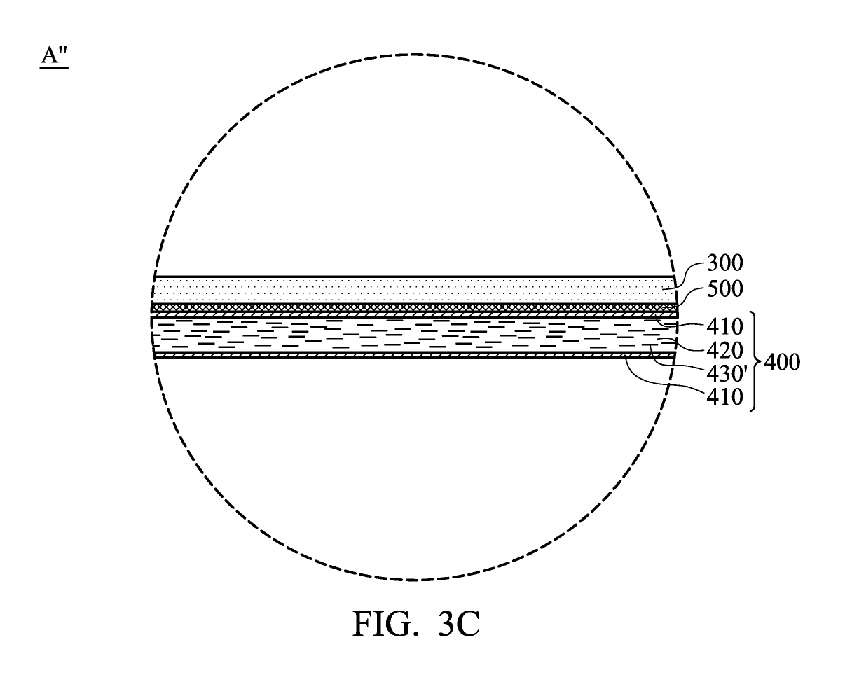

FIG. 2C is a side view of the flexible display device of the embodiment showing the flexible display device inflated or vacuumed. FIG. 3A is a sectional view showing portion A in FIG. 2C. FIG. 3B is a sectional view showing portion A′ in FIG. 2C. FIG. 3C is a sectional view showing portion A″ in FIG. 2C. The flexible air bag 400, made of flexible material, is disposed on the bottom surface of the flexible display panel 300, wherein the flexible air bag 400 is adhesive or buckled to the flexible display panel 300. For example, a connecting layer 500 between the flexible display panel 300 and the flexible air bag 400 is an adhesive layer, a Velcro layer or an engaging layer. The flexible air bag 400 can be fixed on the flexible display panel 300, or it can be connected to the flexible display panel 300 in a detachable manner. In addition, the flexible air bag 400 is inflated or vacuumed when the flexible display panel 300 is in the operating status, such that the surface of the flexible display panel 300 is flat (as shown in FIG. 2C) for convenient viewing. Moreover, the flexible air bag 400 and the flexible display panel 300 are scrolled together in the operating body 200 when the flexible display panel 300 is in the stored status. Note that in this situation, the flexible air bag 400 is deflated or de-vacuumed.

In detail, referring to FIGS. 1 and 3A, the flexible air bag 400 comprises a bag member 410 and a plurality of air tunnels 420. The air tunnels 420 are arranged in parallel with each other and communicate with each other. In addition, the extending direction of the air tunnels 420 is perpendicular to the extending direction of the operating body 200, which allows the flexible air bag 400 to expand when the air tunnels 420 are inflated, so that the flexible display panel 300 is able to be flattened.

In the embodiment, a manual pump or an electronic pump is disposed with in the operating body 200 to connect with the flexible air bag 400, or a pump can be externally connected to the air inlet of the flexible air bag 400 in a detachable manner to inflate or deflate the air tunnels 420.

Additionally, the flexible air bag 400 further comprises a plurality of air valves respectively disposed at the inlets of the air tunnels 420. When one of the air tunnels 420 is damaged, the defected air tunnel 420 is isolated from the other air tunnels 420 due to the corresponding air valve. Therefore, the remaining air tunnels 420 would not be affected. In other words, when one of the air tunnels 420 is damaged, the flexible display panel 300 may still be kept in the flattened status.

Furthermore, the flexible display device 100 further comprises a leak-proof polymeric sealant disposed on the inner surface of the flexible air bag 400. The leak-proof sealant may be a curing type which is able to be cured while reacting with visible light or air. For example, when the flexible air bag 400 is filled with air, a leak-proof sealant which reacts to light is provided in the flexible air bag 400. When the air tunnel 420 is damaged, the leak-proof sealant leaks out to react with ambient light, to automatically cure and repair the damaged area. On the other hand, when the flexible air bag 40 is filled with gas other then air, such as noble gas N2 or Ar, a leak-proof sealant which reacts to air is provided in the flexible air bag 400. When the air tunnel 420 is damaged, the leak-proof sealant leaks out to react with air to automatically cure and repair the damaged area. In addition, the leak-proof sealant may be a solvent-type sealant which is able to be solidified as the solvent in the sealant being evaporated to the atmosphere around the damage area.

Referring to FIG. 3B, in a variant embodiment, the flexible air bag 400 further comprises fiber material 430 disposed in the bag member 410. In this embodiment, the bag member 410 is filled with soft fiber material 430 to connect an inner upper surface with an inner lower surface of the bag member 410. When the flexible air bag 400 is inflated to be expanded, the fiber material 430 may increase the intensity of the structure to withstand the air pressure in order to maintain a flat surface of the flexible display panel 300.

Referring to FIG. 3C, in another variant embodiment, the flexible air bag 400 further comprises fiber material 430′ evenly distributed in the bag member 410. In this embodiment, the bag member 410 is filled with loose fiber material, for example a nonwoven polymeric or metal fiber. When the flexible display panel 300 is in the operating status, the air tunnels 420 are vacuumed to allow the surface layer of the bag member 410 and the fiber material 430′ to be tightened together. By utilizing the hardness of the fiber material 430′ and the friction force formed between the surface layer of the bag member 410 and the fiber material 430′, the structural intensity of the flexible air bag 400 is enhanced to prevent bending. Thus, the flexible display panel 300 may maintain its flatness. The flexible air bag 400 is scrolled and stored again after the air tunnels 420 are de-vacuumed.

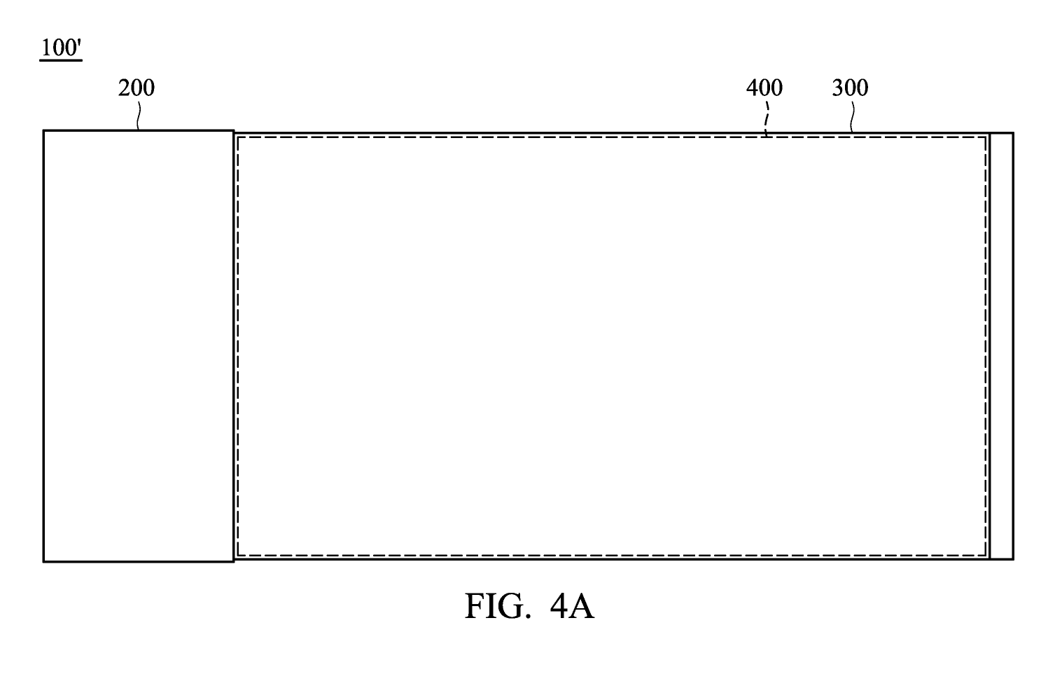

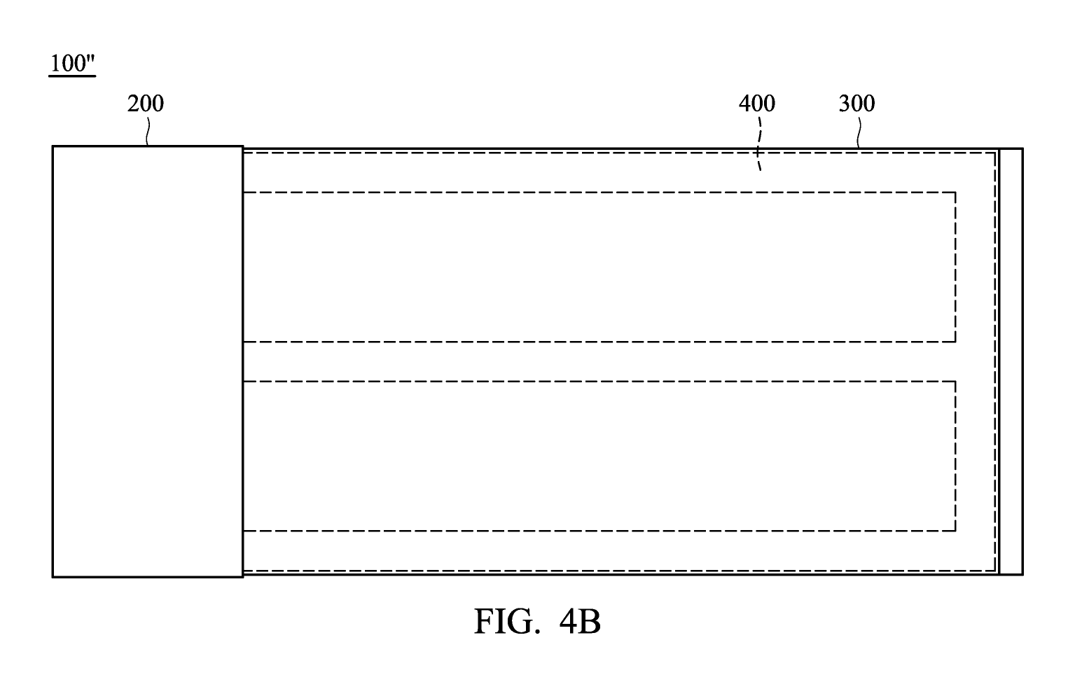

It should be noted that in the above described embodiment, the flexible air bag 400 on the lower surface of the flexible display panel 300 is arranged with air tunnels 420, but it is not limited thereto. FIG. 4A is a top view of a variant embodiment of the flexible display device of the embodiment. Referring to FIG. 4A, in a variant embodiment, the flexible air bag 400 of the flexible display device 100′ may be entirely flat and extend on the lower surface of the flexible display panel 300 without the arrangement of air tunnels. FIG. 4B is a top view of another variant embodiment of the flexible display device of the embodiment. Referring to FIG. 4B, in another variant embodiment, the flexible air bag 400 of the flexible display device 100″ may partially extend on the lower surface of the flexible display panel 300.

In the flexible display device 100, the flexible air bag 400 is combined with the flexible display panel 300, such that the flexible display panel 300 is flattened after the flexible air bag 400 is inflated or vacuumed. When the flexible air bag 400 is stored, no additional space is required, and it is convenient to be carried due to the light fill material.

While the embodiment has been described by way of example and in terms of preferred embodiment, it is to be understood that the embodiment is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A flexible display device, comprising:
an operating body;
a flexible display panel connecting to the operating body and being able to be scrolled or folded to a stored status and unscrolled or unfolded to an operating status; and
a flexible air bag disposed on a bottom surface of the flexible display panel, wherein the flexible display panel is inflated or vacuumed when the flexible display panel is in the operating status in order to maintain a flat surface of the flexible display panel.

2. The flexible display device as claimed in claim 1, wherein the flexible air bag comprises a bag member and fiber material, the bag member has an inner upper surface and an inner lower surface, and the fiber material connects the inner upper surface with the inner lower surface.

3. The flexible display device as claimed in claim 1, wherein the flexible air bag comprises a bag member and fiber material, and the fiber material is filled in the bag member.

4. The flexible display device as claimed in claim 1, wherein the flexible air bag is adhesive or buckled to the flexible display panel.

5. The flexible display device as claimed in claim 1, wherein the flexible air bag comprises a plurality of air tunnels.

6. The flexible display device as claimed in claim 5, wherein the flexible air bag comprises an air inlet communicating with the air tunnels, and an air pump connecting to the air inlet in a detachable manner.

7. The flexible display device as claimed in claim 6, wherein the air tunnels are arranged in parallel with each other and communicate with each other, and the extending direction of the air tunnels is perpendicular to the extending direction of the operating body.

8. The flexible display device as claimed in claim 1, wherein the flexible air bag comprises a plurality air tunnels and a plurality of air valves, and the air valves are correspondingly disposed at entrances of the air tunnels.

9. The flexible display device as claimed in claim 1, wherein the flexible air bag is distributed fully or partially on the surface of the flexible display panel.

10. The flexible display device as claimed in claim 1, further comprising a leak-proof sealant disposed in the inner surface of the flexible air bag, wherein the leak-proof sealant is able to be cured while reacting with light or air.

11. The flexible display device as claimed in claim 1, further comprising a leak-proof sealant disposed in the inner surface of the flexible air bag, wherein the leak-proof sealant is able to be solidified as the solvent in the sealant being evaporated.

12. The flexible display device as claimed in claim 1, further comprising an electronic pump or a manual pump.

13. The flexible display device as claimed in claim 5, wherein the air tunnels are arranged in parallel with each other and communicate with each other, and the extending direction of the air tunnels is perpendicular to the extending direction of the operating body.
